(19) United States
(12) Patent Application Publication
(10) Pub. No.: US 2024/0313262 A1
(43) Pub. Date: Sep. 19, 2024

(54) RECHARGEABLE SOLID STATE LITHIUM BATTERIES WORKING OVER A WIDE TEMPERATURE RANGE

(71) Applicant: VIRGINIA TECH INTELLECTUAL PROPERTIES, INC., Blacksburg, VA (US)

(72) Inventors: Louis A. MADSEN, Blacksburg, VA (US); Feng LIN, Christianburg, VA (US); Deyang YU, Blacksburg, VA (US)

(21) Appl. No.: 18/681,416

(22) PCT Filed: Aug. 6, 2022
(86) PCT No.: PCT/US22/39656

§ 371 Date: Feb. 5, 2024

Related U.S. Application Data
(60) Provisional application No. 63/230,615, filed on Aug. 6, 2021.

(51) Int. Cl. H01M 10/0565; H01M 10/0525

(52) U.S. Cl. CPC H01M 10/0565; H01M 10/0525; H01M 2300/0082; H01M 2300/0091

(57) ABSTRACT

Composite electrolytes are provided that are useful as a solid-state electrolyte in alkali metal batteries. in particular in lithium metal batteries over a wide temperature range. In some aspects. the composite electrolyte includes an alkali metal salt of an aromatic polyimide polymer: and an ionic liquid: wherein the composite is a solid at 25° C. and at a temperature of about 200° C. For example. a molecular ionic composite electrolyte containing 10 wt % PBDT and 90 wt % 1-ethyl-3-methylimidazolium trifluoromethane-sulfonate (EMImTfO) shows an E′ of ≈0.4 GPa and an ionic conductivity of ≈ 3.2 mS cm⁻ at room temperature. In various aspects. batteries are also provided containing a composite electrolyte described herein. The electrolytes enable batteries that are more stable and exhibit less risk of fire or thermal runaway, even when operated at elevated temperatures. In some instances. the alkali metal is lithium and the alkali metal anode is a lithium anode.

### CROSS-REFERENCE TO RELATED APPLICATIONS

This application claims priority to and the benefit of co-pending U.S. provisional application entitled “RECHARGEABLE SOLID STATE LITHIUM BATTERIES WORKING OVER A WIDE TEMPERATURE RANGE” having Ser. No. 63/230,615 filed Aug. 6, 2021.

### STATEMENT REGARDING FEDERALLY SPONSORED RESEARCH OR DEVELOPMENT

This invention was made with government support under award DE-EE0008860 awarded by the Department of Energy. The government has certain rights in the invention.

### TECHNICAL FIELD

The present disclosure generally relates to materials for lithium batteries and lithium batteries made therefrom.

### BACKGROUND

Rechargeable lithium-ion batteries have found wide applications in portable devices, electric vehicles, and electric grids as energy storage devices due to their high energy density [1-3]. However, the electrolytes used in current commercial lithium-ion batteries contain intrinsically volatile and flammable liquid organic carbonates, which can lead to battery fire and explosion in thermal runaway events [4-6]. Such liquid electrolytes restrict the application of lithium-ion batteries at elevated temperatures needed in many applications such as oil drilling, military, aerospace, and the automotive industry [7-10]. For example, the electronics and sensors mounted on drill bits to record geological data in the oil and gas industry need to be powered by batteries that operate in the temperature range from 60 to 120° C. and sometimes even up to 200° C. [7]. Additionally, the utilization of liquid electrolytes also makes it difficult to use lithium metal as an anode to further improve the energy density of lithium batteries, primarily due to lithium dendrite growth and active lithium consumption [11, 12]. Because of these issues, alternative electrolyte materials are desired to meet the wide application demands of high temperature rechargeable lithium batteries.

Solid polymer electrolytes are potential candidates for high temperature lithium battery electrolytes due to the absence of volatile liquid components. Poly(ethylene oxide) (PEO) is the most widely studied polymer electrolyte and has been shown anecdotally to work at up to 120° C. [13]. However, the cycling is not stable and the increased fluidity of PEO at such high temperature may lead to short circuit [14, 15]. Other solid polymers have also been explored but none have shown stable cycling or adequate Coulombic efficiency above 100° C. [7, 8, 16, 17]. Polymer ionic liquid gel electrolytes are also competitors for high temperature lithium battery

electrolytes because of the negligible vapor pressure of ionic liquids (ILs) [18]. However, the incorporation of IL into a polymer matrix usually deteriorates the mechanical properties of the polymer IL gel electrolyte and leads to drastic drop of the storage modulus as temperature increases [19]24]. Additionally, high temperatures often cause IL leakage or melting of polymer IL gel electrolytes [25-28]. Using a rigid polymer matrix appears to be a plausible way to obtain a polymer-IL gel electrolyte with practical mechanical properties at high IL content. Rigid polymers typically have lower solubility in ILs because of the lower entropy gain during dissolution when compared to soft-segment polymers. For example, sulfonated polyimide-IL composites developed in the Watanabe group exhibit room temperature elastic storage modulus >10 MPa at 75 wt % IL, and these materials have been applied to gas separations and nonhumidified intermediate temperature fuel cells [29-33]. Methyl cellulose-IL electrolytes also demonstrate high elastic storage modulus at high IL content [21, 23]. We note that the storage moduli of these materials decrease considerably with temperature, reducing their suitability for wide temperature applications.

There is a need for batteries and battery materials that are less volatile and capable of operating at elevated temperatures.

There is further a need for electrolyte materials that can be used with lithium metal anodes without being hampered by lithium dendrite growth.

There is further a need for solid polymer electrolytes that exhibit stable cycling and can remain solid even at elevated temperatures.

### SUMMARY

In various aspects, composite electrolytes are provided that are useful as a solid-state electrolyte in alkali metal batteries, in particular in lithium metal batteries over a wide temperature range. In some aspects, the composite electrolyte includes an alkali metal salt of an aromatic polyimide polymer; and an ionic liquid; wherein the composite is a solid at 25° C. and at a temperature of about 200° C.]. For example, a molecular ionic composite electrolyte containing 10 wt % PBDT and 90 wt %1-ethyl-3-methylimidazolium trifluoromethanesulfonate (EMImTfO) shows an E′ of ≈0.4 GPa and an ionic conductivity of ≈3.2 mS cm⁻¹ at room temperature. Its E remains above 0.1 GPa even when heated to 300° C., demonstrating excellent mechanical stability at high temperatures

In various aspects, batteries are also provided containing a composite electrolyte described herein. The electrolytes enable batteries that are more stable and exhibit less risk of fire or thermal runaway , even when operated at elevated temperatures. In some instances, the alkali metal is lithium and the alkali metal anode is a lithium anode.

Other systems, methods, features, and advantages of devices, systems, and methods described herein will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIGS. 1A-1C demonstrate the MIC electrolyte membrane and its mechanical properties. FIG. 1A depicts the Chemical structure of polymer, lithium salt, and IL. FIG. 1B is a graph of the stress-strain tests of three MIC electrolyte samples at 23° C. The average tensile modulus is 410 MPa and the average tensile strength is 8.0 MPa. FIG. 1C is a graph of the temperature dependence of the shear storage and loss moduli (G′ and G″) of the MIC electrolyte membrane at a heating rate of 5° C. min⁻¹.

FIG. 2 is a plot of the ¹H NMR of the MIC membrane dissolved in D₂O. Peaks of the IL cation are assigned accordingly. No obvious residual DMF peaks are observed in the spectrum (<0.1 wt % limit of detection).

FIG. 3 is a TGA trace of the MIC membrane at a heating rate of 10° C. min⁻¹ in N₂ atmosphere. The 5% mass loss temperature is 390° C.

FIGS. 4A-4D demonstrate the ion transport properties of the MIC electrolyte membrane. FIG. 4A is a graph of the temperature dependence of the ionic conductivity (σ_{DC}) of the MIC. The solid line in FIG. 4A represents the fit with the VFT equation with parameters listed in Table 1. FIG. 4B is a graph of the temperature dependence of the cation (Pyr₁₄⁺) and anion (TFSI⁻) diffusion coefficients in the MIC and the neat IL. The solid lines in FIG. 4B represent fits with the VFT equation with parameters listed in Table 2. FIG. 4C is a graph of the temperature dependence of the relaxation frequency (ωₘₐₓ) of the MIC. The solid line in FIG. 4C represents the fit with the VFT equation with parameters listed in Table 1. Extrapolating this fit down to 100 s yields a glass transition temperature of −83.6° C. FIG. 4D is a graph of the polarization measurement to determine lithium-ion transference number of the MIC at room temperature. The inset in FIG. 4D shows the impedance spectra before and after polarization.

FIG. 5 is a graph of the frequency dependence of imaginary modulus (M″) of MIC membrane at varying temperatures. The main peak (ωₘₐₓ) is the « molecular motional relaxation, which corresponds to the glass transition of the ionic liquid. The minor peak found at higher frequency at −75° C. is the β relaxation. The DRS dynamic glass transition temperature is the temperature at which the glass transition relaxation time is 100 s. Plotting log (ωₘₐₓ) against 1000/T and extrapolating the curve to 100 s give a DRS dynamic glass transition temperature of −83.6° C.

FIG. 6 is a graph of the lithium-ion transference number (DC polarization) analysis of the MIC membrane at 100° C. The insert in FIG. 6 shows the impedance spectra of Li/MIC/Li cell before and after polarization.

FIGS. 7A-7C demonstrate lithium symmetric cell performance. FIGS. 7A-7B plot the voltage profiles of symmetric cells cycled at 23° C. and 60° C. (FIG. 7A), and 100° C. and 150° C. (FIG. 7B) with increasing steps of current density. The charge and discharge time is 0.5 h, respectively, and the current density (labeled above each step in mA cm−2) is stepped every 10 cycles. FIG. 7C is a graph of the long-term voltage profiles of symmetric cells cycled at 23° C. using a current density of 0.1 mA cm⁻² and 100° C. using a current density of 0.6 mA cm⁻².

FIG. 8 is a graph of the voltage profile of Li/MIC/Li cell cycled at 100° C. using a current density of 0.6 mA cm⁻². The lithium stripping and plating time for each cycle is set to 5 hours. Polarization of the cell increases only slightly within 180 hours.

FIGS. 9A-9B demonstrate the morphological study of lithium deposited on Cu foil using Cu/MIC/Li cells. (a) FIG. 9A is an SEM image of lithium deposited on Cu foil at 23° C. with a current density of 0.05 mA cm⁻² for 20 hours. FIG. 9B is an SEM image of lithium deposited on Cu foil at 150° C. with a current density of 0.5 mA cm-2 for 8 hours. Insets in FIGS. 9A-9B are images of the entire Cu foil with diameter of 16 mm after lithium deposition. For both cases, no dendritic lithium growth is observed.

FIG. 10 is a plot of the rate capability of Li/MIC/LiFePO₄ coin cell at 23, 60, and 100° C. The mass loading of LifePO₄ in the cathode material is 3 mg cm⁻², and so 1 C rate corresponds to a current density of 0.5 mA cm⁻². FIG. 11 shows the rate capability of a coin cell with a LiFePO₄ mass loading of 5.6 mg cm⁻² thick electrode cycled at 100° C.

FIG. 11 is a plot of the rate capability of a Li/MIC/LiFePO4 cell cycled at 100° C. The mass loading of LifePO₄ in the cathode is 5.6 mg cm⁻². The constant voltage charging process is absent from the cycling protocol for this measurement. The rate capability of this thick electrode is only slightly inferior to that of a thin electrode. This difference might be caused by insufficiently connected ionic pathways in the thick electrode, which will likely improve with material processing changes.

FIG. 12 is a graph of the cycling stability test of two Li/MIC/LiFePO₄ cells at 100° C. The mass loading of LifePO₄ in the cathodes are 5.0 and 5.6 mg cm⁻², respectively. These cells are cycled at C/10 rate for 5 cycles followed by 200 cycles at 1C rate. The constant voltage charging process is absent from the cycling protocol for this measurement.

FIGS. 13A-13D demonstrate great cycling stability over a wide temperature range from 23 to 150° C. for Li/MIC/LiFePO₄ coin cells. The Li/MIC/LiFePO₄ coin cells are cycled at 23° C. at C/10 (FIG. 13A), 60° C. at C/3 (FIG. 13B), 100° C. at 1C (FIG. 13C), and 150° C. at 1 C (FIG. 13D). Inset figures in each of FIGS. 13A-13D are the voltage profiles for selected cycles under each cycling condition. Cycling stability of more coin cells are presented in FIGS. 14-17. The cycling performance at 23 and 60° C. for 500 cycles is very reproducible. At 100 and 150° C., there is a large variation at how many cycles these coin cells can last. This may be caused by oxygen penetration into the coin cells due to the poor mechanical stability of the gasket at such high temperatures.

FIG. 14 is a graph of the specific capacity of two additional Li/MIC/LiFePO₄ coin cells cycled at 23° C. using a charge/discharge rate of C/10. The maximum specific capacity for these cells are 150 mAh g⁻¹ and the capacity retention after 400 cycles are 95% and 89%, respectively. The performance of these two cells agrees very well with the cell shown in FIG. 13A demonstrating the reproducibility of cell performance at 23° C. and C/10 rate.

FIG. 15 is a graph of the specific capacity of two additional Li/MIC/LiFePO₄ coin cells cycled at 60° C. using a charge/discharge rate of C/3. The drastic specific capacity change in one cell during cycling is caused by temperature fluctuations during loading of other cells into this oven at 160, 169, and 344 cycle numbers. The maximum specific capacity for these cells are 160 mAh g⁻¹ and the capacity retention after 500 cycles are 71% and 84%, respectively. The performance of these two extra cells agrees well with the cell shown in FIG. 13B demonstrating the reproducibility of cell performance at 60° C. and C/3 rate.

FIG. 16 is a graph of the specific capacity of two additional Li/MIC/LiFePO₄ coin cells cycled at 100° C. using a charge/discharge rate of 1C. The initial specific capacities are 160 mAh g⁻¹. One of the cells lasts for nearly 200 cycles and the other one survives 500 cycles with a capacity retention of 57%.

FIG. 17 is a graph of the specific capacity of two additional Li/MIC/LiFePO₄ coin cells cycled at 150 C using a charge/discharge rate of 1C. These two cells last for 50 and 170 cycles, respectively. No drastic capacity decay is observed before cell failure, so the failure may be caused by the reduced mechanical property of the coin cell gasket material at this high temperature.

FIG. 18 is a graph of the CV of MIC membrane and a liquid electrolyte composed by LiTFSI and Pyr₁₄TFSI in a 1:8 mass ratio. These CV measurements are recorded with a scan rate of 0.1 mV s⁻¹ at room temperature using stainless steel as working electrode and lithium metal as counter and reference electrode. The main peak near 0 V corresponds to lithium plating and stripping. The reductive peaks at 0.7 V and 1.5 V and oxidative peaks at 1.0 V and 2.0 V are observed both in the MIC and the liquid electrolyte suggesting they are caused by the IL. An oxidative peak at 3.9 V is observed only in the MIC membrane, indicating it is caused by either the polymer or an impurity.

FIGS. 19A-19C demonstrate the MIC membrane maintains mechanical integrity after Li/MIC/LiFePO₄ cell cycling at 60 and C/3 rate for 500 cycles. FIG. 19A is an image of MIC membrane together with the cathode and anode after cycling. FIG. 19B is an SEM image of the membrane surface facing cathode. FIG. 19C is an SEM image of the membrane facing the lithium metal anode.

FIGS. 20A-20B demonstrate the EIS of Li/MIC/LiFePO₄ coin cells cycled at 150° C. with (FIG. 20A) and without (FIG. 20B) the constant voltage charging process. Number on the traces indicates the number of cycle after which EIS was recorded. A dramatic increase in the interfacial resistance is observed only when applying the constant voltage charging process at 4.2 V to the cycling protocol. When this constant voltage charging process is removed from the protocol, the interfacial resistance of the cell remains stable during cycling.

FIGS. 21A-21B graph the voltage profile (FIG. 21A) and cycling performance (FIG. 21B) of Li/LiFePO₄ cell using a PVDF-HFP based composite polymer electrolyte at 100° C. and C/3 rate. The numbers in FIG. 21A are the number of cycles and the inset is the 10th cycle. The Coulombic efficiency of this cell is only around 80% during the first few cycles suggesting the existence of severe side reactions. When compared to the performance of coin cells made with MIC as solid electrolyte, we propose that the mechanical stability of the electrolyte at elevated temperature is crucial for high temperature lithium metal batteries as the mechanical integrity of PVDF-HFP based gel electrolyte is greatly reduced at 100° C.

### DETAILED DESCRIPTION

Molecular ionic composites (MICs) are a type of solid electrolyte material constructed from an array of ionic liquids and rigid-rod polymer materials such as poly(2,2′-disulfonyl-4,4′-benzidine terephthalamide) (PBDT) [34-36]. PBDT is a rigid-rod highly sulfonated aromatic polyamide. The tensile storage modulus (E′) of PBDT is 9 GPa at 25° C. and remains above 6

GPa even when heated to 350° C. MICs maintain the high rigidity of the polymer, and exhibit

moduli higher than most polymer-IL gel electrolytes [36]. Most importantly, the mechanical rigidity of MICs is not jeopardized at high temperatures, and thus mechanically robust MICs with very low polymer content can enable high ionic conductivity [34-36]. For example, a MIC containing 10 wt % PBDT and 90 wt % 1-ethyl-3-methylimidazolium trifluoromethanesulfonate (EMImTfO) shows an E′ of =0.4 GPa and an ionic conductivity of =3.2 mS cm-1 at room temperature [36, 37]. Its E remains above 0.1 GPa even when heated to 300° C., demonstrating

excellent mechanical stability at high temperatures [36]. The high modulus of PBDT combined with the collective ionic (electrostatic) interactions in the MICs, forms the basis for the mechanical stability of this material [38]. Investigations also show that MICs phase separate into a continuous loadbearing polymer-rich fibrous “bundle” phase and an IL-rich “puddle” phase [35, 36]. This phase separation amplifies the combination (product) of high modulus and high conductivity while enabling such low polymer content. Due to the unique combination of mechanical stability at elevated temperature and high ionic conductivity, MICs are promising candidates for electrochemical devices where a wide working temperature range is required.

In some aspects provided herein is a MIC electrolyte membrane composed of 10 wt % PBDT, 10 wt % lithium bis(trifluoromethylsulfonyl)imide (LiTFSI), and 80 wt %1-butyl-1-methylpyrrolidinium bis(trifluoromethylsulfonyl)imide (Pyr₁₄TFSI) used as solid electrolyte for lithium metal batteries. The cycling performance of Li/MIC/Li symmetric cells and Li/MIC/LiFePO₄ cells studied at 23, 60, 100, and 150° C. demonstrate that MICs are high-performance solid electrolyte materials for wide temperature range lithium metal batteries.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, techniques of computer science, artificial intelligence, and natural language processing and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

In some instances, units may be used herein that are non-metric or non-SI units. Such units may be, for instance, in U.S. Customary Measures, e.g., as set forth by the National Institute of Standards and Technology, Department of Commerce, United States of America in publications such as NIST HB 44, NIST HB 133, NIST SP 811, NIST SP 1038, NBS Miscellaneous Publication 214, and the like. The units in U.S. Customary Measures are understood to include equivalent dimensions in metric and other units (e.g., a dimension disclosed as “1 inch” is intended to mean an equivalent dimension of “2.5 cm”; a unit disclosed as “1 pcf” is intended to mean an equivalent dimension of 0.157 KN/m3; or a unit disclosed 100° F. is intended to mean an equivalent dimension of 37.8° C.; and the like) as understood by a person of ordinary skill in the art.

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

### EXAMPLES

In this example, a MIC electrolyte membrane is prepared that is composed of PBDT, lithium bis(trifluoromethylsulfonyl) imide (LiTFSI), and 1-butyl-1-methylpyrrolidinium bis (trifluoromethylsulfonyl)imide (Pyr₁₄TFSI) in a mass ratio of 10:10:80. The ionic conductivity at 25° C. is 0.56 mS cm-1 with no added flammable/volatile components. Although the polymer content is only 10 wt %, this MIC membrane is rigid with a tensile modulus of 410 MPa at room temperature. The MIC membrane remains stable and rigid at 200° C. with the shear storage modulus (G′) only slightly decreasing by 35%. Li/MIC/LiFePO₄ cells demonstrate stable cycling performance over a wide temperature range from 23 to 150° C. The specific discharge capacity at 100 and 150° C. at 1 C rate exceeds 160 mAh g⁻¹. The discharge capacity retention is 99% after 50 cycles at 150° C. This stable battery performance shows that this low polymer content MIC membrane qualifies for use as a solid electrolyte in lithium metal batteries operating over a wide temperature range.

### Materials

PBDT with Li⁺ counter ion was synthesized in a similar way as previously reported except Na₂CO₃ was replaced with Li₂CO₃_[71, 72]. 1-butyl-1-methylpyrrolidinium bis (trifluoromethylsulfonyl) imide (Pyr₁₄ TFS!) 99% was purchased from lolitec Inc. (Germany) and used as received. Lithium bis(trifluoromethylsulfonyl)imide (LiTFSI) 98+% was purchased from Alfa Aesar and used as received.

### MIC Membrane Preparation

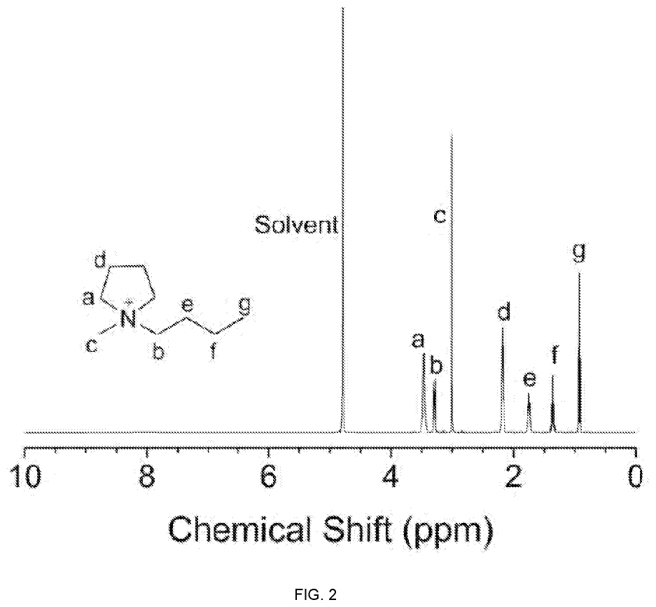

The MIC electrolyte was prepared as follows. 0.12 g PBDT was dissolved in 12 g H₂O. 0.12 g LiTFSI and 0.96 g Pyr₁₄TFSI were dissolved in 12 g DMF. After heating the above two separate solutions to 85° C., they were mixed together with vigorous stirring. After equilibrating at 85° C. overnight, the mixed solution was poured onto a 10×10 cm² glass substrate and dried at 85° C. in a Yamato DX600 oven overnight. The MIC membrane was peeled off the glass substrate and transferred to a vacuum oven for further drying at 100° C. for 2 days. The complete removal of DMF from the membrane was examined via ¹H NMR (FIG. 2) . For oscillatory shear measurements and DRS measurements, 0.59 mm thick and 0.22 mm thick membranes were cast, respectively, in a 100 ml glass beaker.

### DRS

Dielectric measurements of the MIC film were carried out using a Novocontrol GmbH Concept 40 broadband dielectric spectrometer. The 0.22 mm thick film was sandwiched between a polished 10 mm circular brass electrode and a polished 20 mm brass electrode and placed under vacuum for 80° C. for 1 h. This was to remove any moisture from the film and to enable the MIC to adhere to the electrodes. The sandwich was then loaded into the Novocontrol and annealed at 120° C. under nitrogen for an additional hour to remove any residual moisture absorbed during sample loading. Isothermal dielectric data were then collected by applying a sinusoidal voltage with an amplitude of 0.1 V over a frequency range of 10⁻¹-10⁷ Hz. These data were collected in steps of 10° C. on cooling from 120 to-100° C. followed by steps of 5° C. in heating from −100 to 200° C. Ionic conductivity (σ_{DC}) of the MIC membrane was taken from the real part of the frequency-dependent complex conductivity (σ′) on heating where o′ was independent of frequency.

### NMR Diffiisometry

Diffusion measurements were performed using the pulsed-gradient stimulated-echo (PGSTE) sequence on a 600 MHz Bruker Avance III NMR spectrometer with a 5 mm Doty, standard VT, ¹H/X high gradient PEFG probe. Self-diffusion coefficients of the cation and anion of the IL were obtained by measuring the ¹H and ¹⁹F nuclei, respectively. The Stejskal-Tanner

equation was used to fit the measured signal intensity (/) at varying gradient strength (g) to extract the diffusion coefficient (D)

$$I = {I}_{0} exp [ - {g}^{2} {δ}^{2} {γ}^{2} D ( Δ - \frac{δ}{3} ) ] \qquad 1 )$$

where l₀ is the signal intensity at g=0, γ is the nucleus gyromagnetic ratio, δ is the effective gradient pulse duration time, and Δ is the diffusion time. When measuring the diffusion coefficient of Pyr₁₄⁺ in the MIC electrolyte, δ=1.5 ms, Δ=120 ms, repetition time was set to 2 s, and the acquisition time was set to 0.1 s. For the measurement of TFSI-, Δ was changed to 150 ms, acquisition time was changed to 0.05 s, and the repetition time varied from 1 to 2 s to adjust for varying T₁ at different temperatures. When measuring the diffusion coefficients of pure Pyr₁₄TFSI, o δ=2.0 ms, Δ=100 ms, a repetition time of 3 s, and an acquisition time of 1 s were used. All of the diffusion coefficients were measured in 16 steps, and the maximum gradient strength was varied from 50 to 550 G cm⁻¹ based on the sample, temperature and measured nucleus.

SEM, Thermogravimetric Analysis (TGA), Uniaxial Tension, and Oscillatory Shear Measurements

SEM images were taken on an LEO (Zeiss) 1550 field emission SEM with an acceleration voltage of 5.0 kV. TGA was measured on a TGA-Q500 under N₂ atmosphere with a heating rate of 10° C. min-1. Stress-strain tests were measured on a TA instruments DMA Q800 at room temperature with a strain rate of 1% min⁻¹. Three samples were measured and the tensile modulus was taken from the average slope of the stress-strain curves below 0.3% strain. Temperature-dependent shear storage and loss moduli (G′ and G″ were measured using an Advanced Rheometric Expansion System (ARES)-G2 rheometer from 0 to 300° C. at a heating rate of 5° C. min⁻¹ Prior to measurement, the MIC membrane was kept under vacuum at 80° C. for 1 h to remove residual moisture. The sample was then loaded onto 3 mm disposable aluminum plates and measured using an angular frequency of 1 rad s⁻¹with 0.1% strain. Prior to the measurement, a strain sweep was done to confirm that 0.1% strain was in the linear viscoelastic region of strain amplitude.

### Electrochemical Measurements

Electrochemical impedance spectroscopy (EIS), cyclic voltammetry (CV) , and DC polarization were conducted on a Biologic SP-200 instrument. EIS was recorded using an AC amplitude of 10 mV with the applied signal frequency ranging from 5×10⁶ to 1×10⁻¹ Hz. CV was measured at room temperature using a Li/MIC/stainless steel cell configuration with a scan rate of 0.1 mV s⁻¹ in the voltage range from −0.2 to 4.5 V (vs Li⁺/Li). Lithium-ion transference number (t_{Li+}) was measured following the method reported by Evans et al.[74] using a lithium symmetric coin cell configuration at room temperature with a constant DC voltage bias (ΔV) of 10 mV. Lithium-ion transference number was calculated using the following equation

$${t}_{Li +} = \frac{{I}_{S} ( Δ V - {I}_{0} {R}_{0} )}{{I}_{0} ( Δ V - {I}_{S} {R}_{S} )} \qquad 2 )$$

where I₀ and I_{S}, are the initial current and the steady state current after 1 h while R₀ and R_{S} are the interfacial resistance before and after DC polarization measured by EIS.

### Coin Cell Tests:

For the Li/MIC/LiFePO₄ coin cells, the anode was lithium metal and the cathode was a LiFePO₄ composite material prepared as previously reported [64]. The mass ratio between Li FePO₄ active powder, carbon black, and polyvinylidene difluoride was 8:1:1. The mass loading of LifePO₄ is 3 mg cm⁻². Li/MIC/LiFePO₄ cells and lithium symmetric cells were assembled and sealed into CR2032 coin cells using a crimper (MTI MSK-160E) in an Ar-filled glovebox. Cycling performance of the coin cells was collected on a LAND battery testing system and a Neware battery test system using a galvanostatic charge/discharge protocol from 23 to 150° C. The critical current of lithium symmetric cells was quantified by increasing current density in steps. Cycling performance of lithium symmetric cells was investigated at 23 and 100° C. using a current density of 0.1 and 0.6 mA cm⁻², respectively. Both the charge and discharge time were 0.5 h for the lithium symmetric cells. Li/MIC/LiFePO₄ coin cells were cycled between 2.7 and 4.2 V. The galvanostatic charging process is followed by a 30 min constant voltage charging at 4.2 V when cycling Li/MIC/LiFePO₄ coin cells at 23, 60, and 100° C. The Coulombic efficiency is calculated using the following equation

$$Coulombic efficiency = \frac{Discharge capacity}{Charge capacity} \times 100 \% \qquad 3 )$$

### Results and Discussion

### MIC Membranes and Mechanical Properties

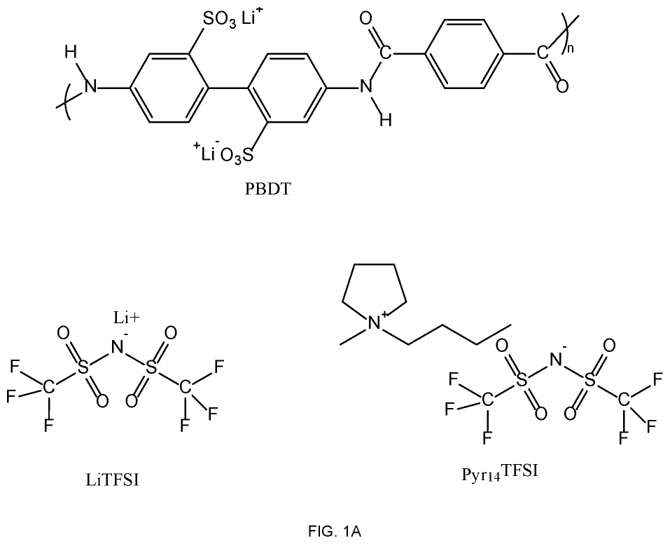

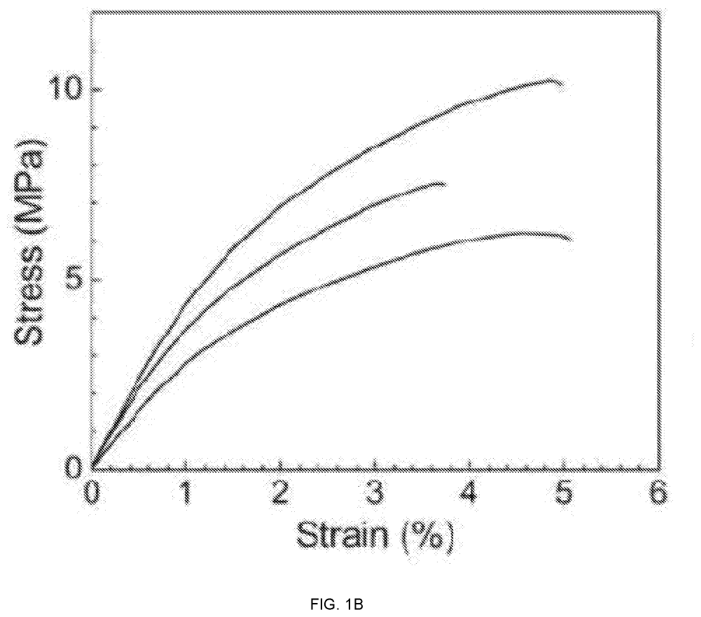

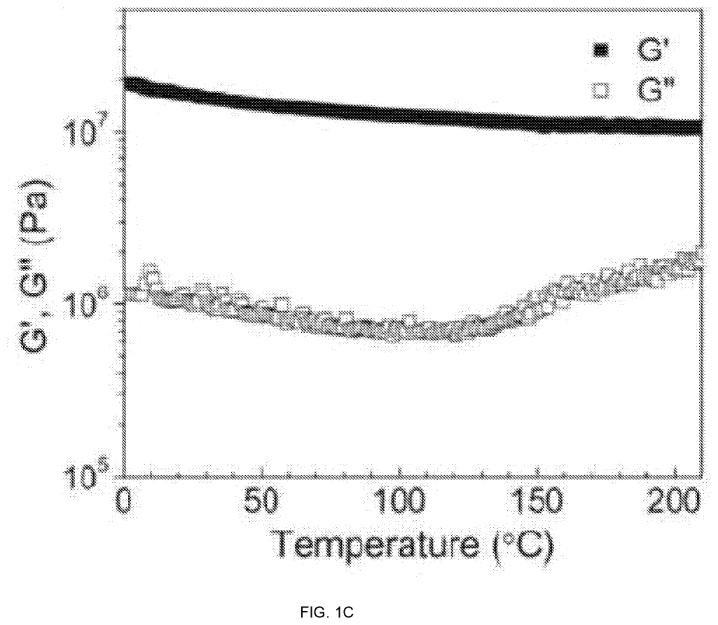

The structure of PBDT is shown in FIG. 1A. LiTFSI is used to increase the concentration of Li⁺ in the MIC membrane. Pyr₁₄TFSI is an IL widely studied as a component for lithium battery electrolytes with a wide electrochemical window and stable cycling performance against lithium metal [26, 39-41] MIC electrolyte membranes can be readily obtained by dissolving PBDT, LiTFSI, and Pyr₁₄TFSI in a mass ratio of 10:10:80 in a mixture of H₂O and DMF (N,N-dimethylformarnide) followed by drop casting and solvent evaporation to form MIC electrolyte membrane with thickness of 80 μm and area of 100 cm². The mass ratio of PBDT: LiTFSI:Pyr₁₄ TFSI is 10:10:80. [37]. While the composition and properties of the membrane can be easily tuned, the goal of this example is to demonstrate the potential of MIC materials as solid electrolytes for wide-temperature range lithium metal batteries. Thus, MIC membranes with the same composition are used for all the measurements in this example. The casted membrane can bend and twist multiple times without breaking. Although the polymer content is only 10 wt %, the membrane shows the toughness and flexibility required for a polymer battery electrolyte. The membrane demonstrates the flexibility and robustness necessary for a range of battery designs.

Mechanical strength is an important parameter for polymer electrolytes as they also play the role of separators. Polymer electrolytes need to remain mechanically stable when stress arises during manufacturing, cell assembly, storage, and usage [42, 43]. In particular, the periodic volume change of electrode active materials during battery cycling exerts periodic strain on the separator [44, 45]. Uniaxial stress-strain testing (FIG. 1B) shows that the tensile modulus, tensile strength, and strain at break of the MIC electrolyte membrane are 410 +53 MPa, 8.0±1.2 MPa, and 4.6%±0.43%, respectively, at room temperature. The high modulus and low strain at break suggests that this low polymer content (10 wt %) MIC membrane is rigid. It is important to note that the tensile strength is even higher than some chemically crosslinked polymer-IL systems with much higher polymer content [19, 46-48]. For example, the tensile strength of crosslinked poly(methyl methacrylate) (PMMA)-EMImTFSI with 30 wt % polymer content is no more than 1.3 MPa [47].

When used in high temperature environments, the mechanical integrity of polymer electrolytes should be sufficient to prevent internal short-circuiting and self-discharge [14, 43, 49] Here, the mechanical stability of the MIC at elevated temperature is studied through oscillatory shear rheology. As shown in FIG. 1C, the shear storage modulus (G′) of the MIC electrolyte membrane demonstrates only a slight decay from 16.2 MPa at 25° C. to 10.5 MPa at 200° C. This slight decrease in G′ shows good agreement with a previous rheological study of another MIC system [35], signifying that the rigidity of the MIC membrane is retained up to 200° C., which suggests that the intermolecular interactions responsible for mechanical properties in the MIC membrane are not weakened at high temperature. For comparison, a PMMA gel electrolyte with ethylene carbonate (EC)-propylene carbonate (PC) as plasticizer and LiCIO₄ as lithium salt (with a weight ratio of PMMA:(EC-PC)=1:2) shows a G′ of 100 kPa at room

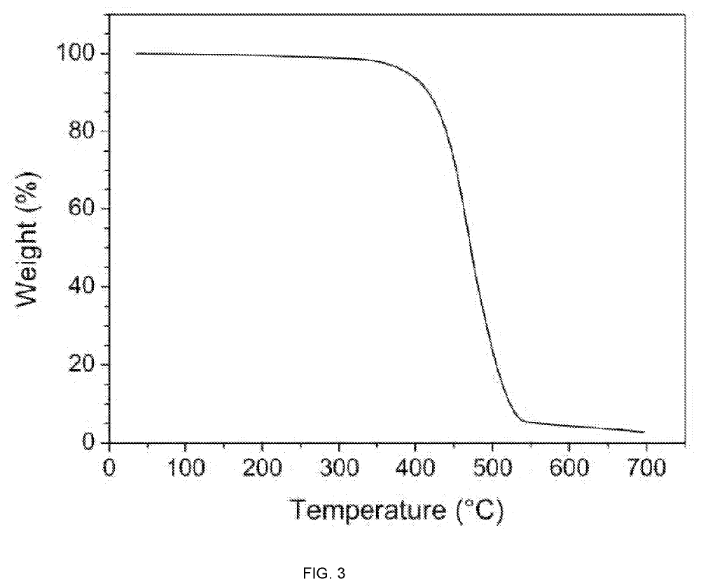

temperature and the system undergoes a gel-sol transition when heated above 120° C. [50]. The MIC also shows great thermal stability, with a 5% mass loss temperature as high as 390° C. as determined by thermogravimetric analysis under nitrogen (FIG. 3). The excellent mechanical stability of this MIC membrane at elevated temperature makes it an appealing solid electrolyte for electrochemical devices requiring a wide working temperature range.

### Ion Transport Properties

Investigating the kinetics of ion transport is beneficial for developing and refining new electrolyte materials. Ionic conductivity, NMR diffusometry, and lithium-ion transference number have been measured and analyzed to better understand the dynamics of charge transport of each mobile ion species (Pyr₁₄⁺, TFSI⁻, and Li⁺) within the MIC membrane. Ionic conductivity measures the total charge transport of all mobile ions, while lithium-ion transference number evaluates only the contribution from Li⁺ to ionic conductivity, and NMR diffusometry provides self-diffusion coefficients for the separate ions Pyr₁₄⁺ and TFSI⁻.

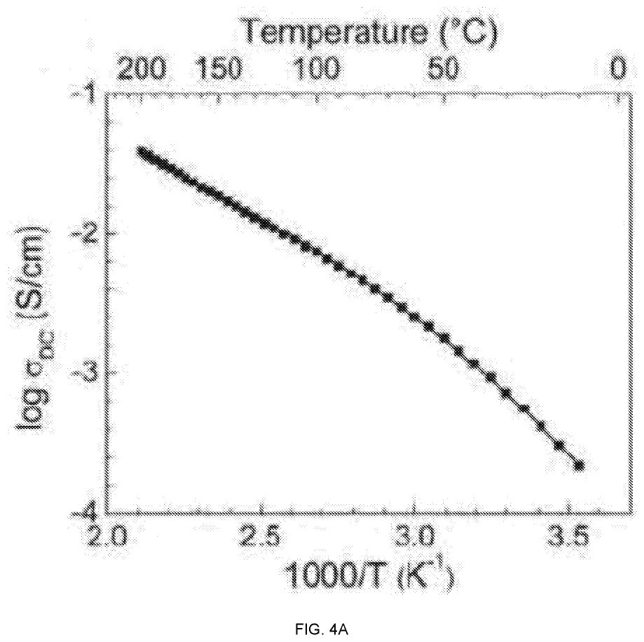

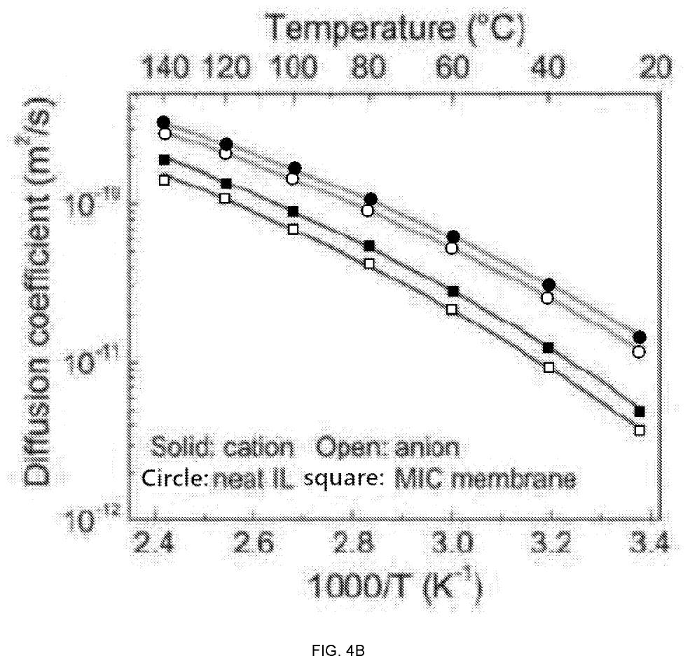

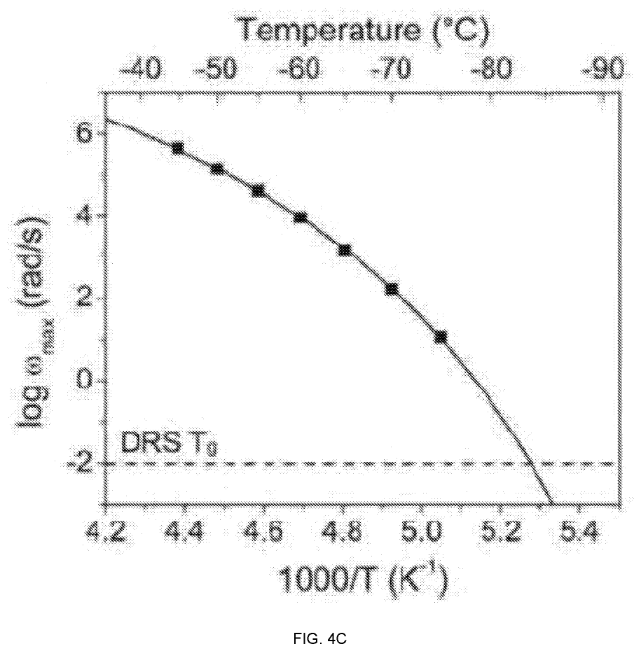

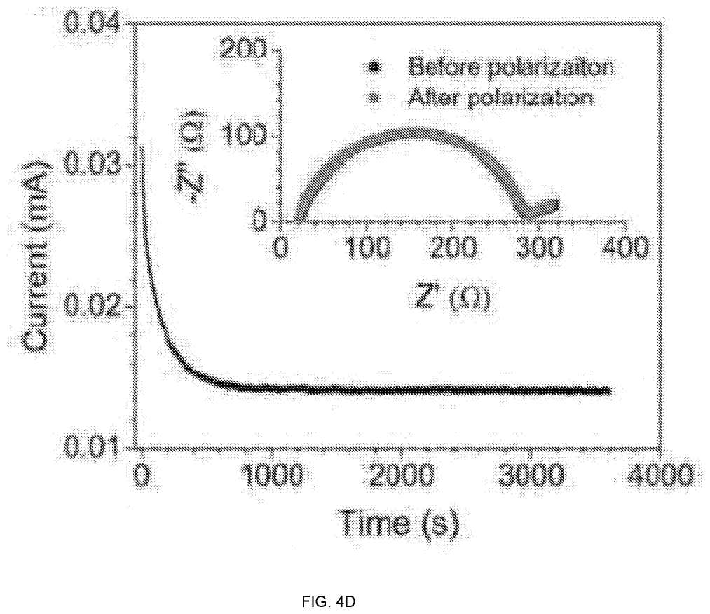

The ionic conductivity of the MIC membrane is measured as a function of temperature using dielectric relaxation spectroscopy (DRS) as illustrated in FIG. 4A. The ionic conductivity of the MIC membrane at 25° C. is 0.56 ms cm⁻¹. This is only a factor of 4 smaller than the ionic conductivity of the neat IL, which is 2.2 ms cm⁻¹ [51]. The conductivity increases with temperature, and at 200° C. the conductivity reaches 39 ms cm⁻¹, strongly suggesting this MIC can serve as a fast ion conductor for high temperature electrochemical devices.

Self-diffusion coefficients of Pyr₁₄⁺ and TFSI⁻ in the MIC membrane are measured from 23 to 140° C. and compared to those of the neat IL (FIG. 4B). The neat IL diffusion coefficients agree closely with literature values [52]. At 23° C. the diffusion coefficients of IL in the MIC are only a factor of 3 smaller when compared to neat IL. The decrease in conductivity between the MIC and neat IL is larger than the decrease in diffusion coefficients, which may be caused by

the higher degree of ion associations in the MIC membrane in the presence of Li⁺ [53]. The measured self-diffusion coefficient is an overall average of all diffusing molecules probed in the system. Therefore, the diffusive motion of neutral ionic clusters will contribute to the diffusion coefficient. However, the motion of neutral ionic clusters causes no net charge transport (as probed by DRS), thus causing no contribution to ionic conductivity. When the temperature is increased to 140 from 23° C., the diffusion coefficients Pyr₁₄⁺ and TFSI-increase by a factor of 39, which nearly matches the degree of ionic conductivity increase (a factor of 33) over the same temperature change.

Both conductivity and diffusion coefficients are fitted with Vogel-Fulcher-Tammann (VFT) equations

$${σ}_{DC} = {σ}_{∞} exp ( \frac{- {BT}_{0}}{T - {T}_{0}} ) \qquad 4 )$$

$$D = {D}_{∞} exp ( \frac{- {BT}_{0}}{T - {T}_{0}} ) \qquad 5 )$$

where the prefactor σ_{∞}/D_{∞} is the ionic conductivity/diffusion coefficient at infinite temperature, B is a dimensionless parameter related to fragility, which describes the degree of deviation of the system from Arrhenius behavior [54], and T₀ is the Vogel temperature. The fitting parameters are summarized in Tables 1 and 2. The same T₀ (160 K) is used for both the ionic conductivity and diffusion coefficient VFT fits. These fits match well with the data, suggesting that the ion transport mechanism probed by the two methods is similar.

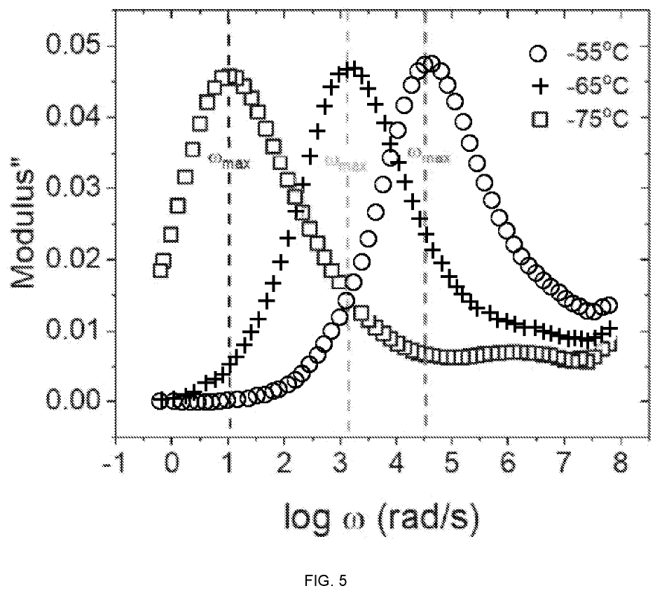

To further understand the mechanism behind ion transport in MIC membrane, we analyzed the dielectric relaxation frequency of the MIC membrane at lower temperatures through DRS. A well resolved dielectric relaxation frequency (ωₘₐₓ) is identified. from the frequency-dependent imaginary electrochemical modulus (M″) (FIG. 5).

The temperature dependence of this relaxation frequency (FIG. 4C) is also fitted using the VFT equation with T₀=160 K, emphasizing that the ionic conductivity strongly couples to this dielectric relaxation.

$${ω}_{max} = {ω}_{∞} exp ( \frac{- {BT}_{0}}{T - {T}_{0}} ) \qquad 6 )$$

Extrapolating the VFT fit down to 100 s [55], provides a DRS dynamic glass transition temperature of 189.6 K (−83.6° C.). This value is identical to the differential scanning calorimetry glass transition temperature of Pyr₁₄TFSI in MIC membranes prepared from sodium-form PBDT and Pyr₁₄TFSI [37], while also being very close to the glass transition of neat IL at −87° C. [51]. This suggests that diffusive motion of the ions dominates the ion transport mechanism in MICs, which differs from dry polymer electrolytes where ion transport is coupled to the segmental motion of polymer. We believe this decoupling arises from the high rigidity of PBDT and its relatively low content in MICs [56, 57].

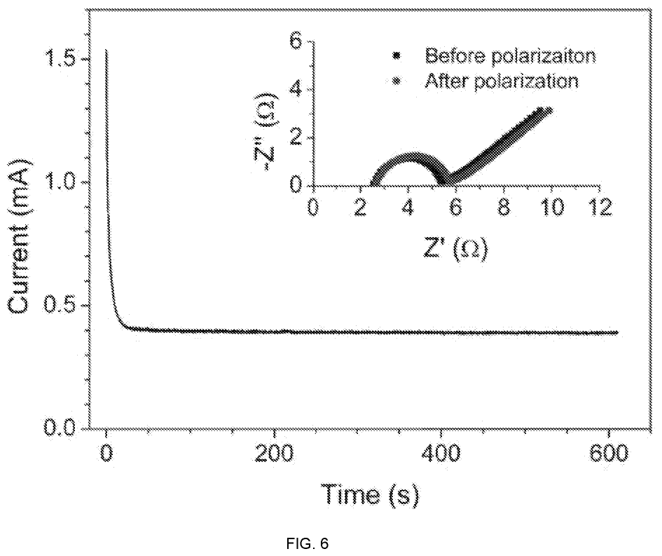

Battery performance is directly related to Li⁺ transport dynamics during cycling processes, so it is critical to know the contribution of Li⁺ to the total conductivity. Lithium-ion transference number (t_{Li+}) of the MIC membrane is 0.12 at room temperature (FIG. 4D). This value is smaller than those of liquid carbonate electrolytes, which are typically 0.2-0.4 [6, 58]. Pyr₁₄⁺ and TFSI⁻ are major contributors to conductivity due to their relatively high concentration in the MIC membrane. The t_{Li+} is 0.14 when measured at 100° C. (FIG. 6), showing no obvious change with increasing temperature.

TABLE 1
VFT fitting parameters for ionic conductivity
and dielectric relaxation of the MIC membrane.

| Ionic | Dielectric |
|---|---|
| Conductivity | Relaxation |

| σ_{∞}[S cm⁻¹] | B | T₀[K] | ω_{∞}[rad s⁻¹] | B | T₀[K] |
|---|---|---|---|---|---|
| 0.952 | 6.44 | 160 | 2.97 × 10¹¹ | 5.73 | 160 |

TABLE 2
VFT fitting parameters for diffusion coefficients
of the cation (Pyr₁₄⁺) and anion (TFSI⁻) in the
MIC membrane and in neat Pyr₁₄TFSI.

| | | D_{∞}[m² s⁻¹] | B | T₀[K] |
|---|---|---|---|---|
| MIC membrane | Cation | 1.37 × 10⁻⁸ | 6.70 | 160 |
| | Anion | 1.14 × 10⁻⁸ | 6.81 | 160 |
| Pyr₁₄TFSI. | Cation | 1.18 × 10⁻⁸ | 5.69 | 160 |
| | Anion | 1.15 × 10⁻⁸ | 5.84 | 160 |

### Electrochemical Cycling of MIC Electrolyte with Lithium Metal

Lithium metal is a highly desirable anode for lithium batteries due to its high theoretical capacity and low electrochemical potential. However, the high reactivity and dendrite growth

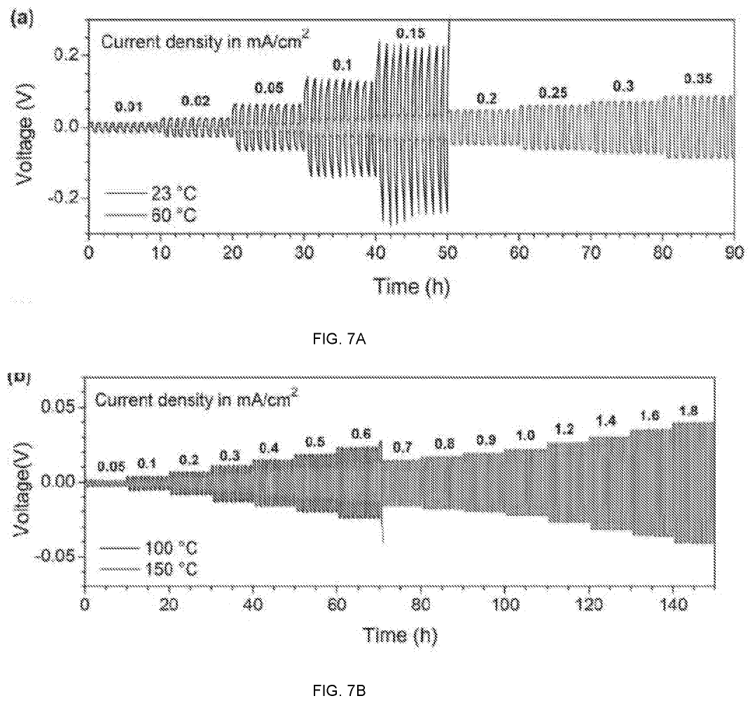

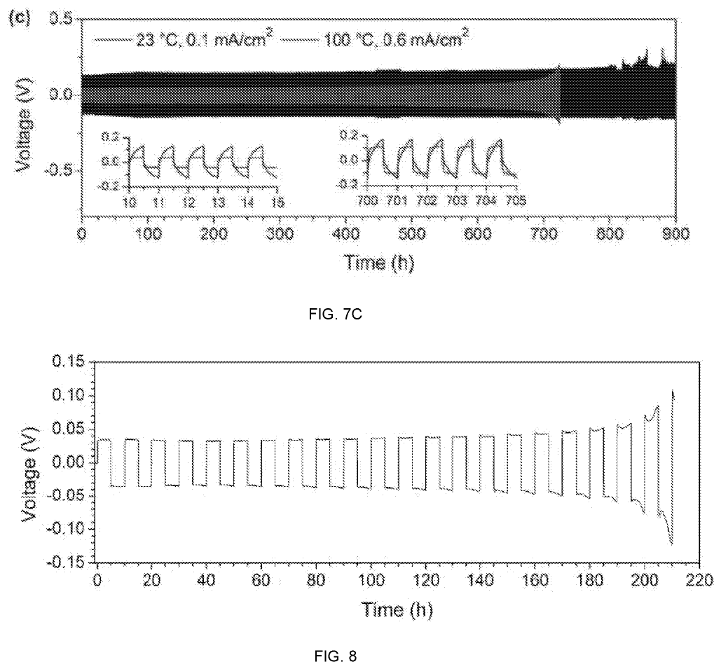

issue have prevented the wide commercialization of lithium metal batteries [59]. To investigate the compatibility between MIC membrane and lithium metal, lithium symmetric cells are assembled and cycled at various current densities and temperatures (FIGS. 7A-7C). At 23° C. (FIG. 7A), the observed voltage increases slowly during the lithium stripping process,

corresponding to the establishment of a salt concentration gradient across the cell [60]. The maximum voltage reached during one cycle increases monotonically with current density. When the current density is increased to 0.2 mA cm⁻² the voltage increases drastically to above 5 V, suggesting the concentration of Li⁺ at the anode surface is approaching zero and the limiting

current density is reached [61]. Since ionic conductivity increases with temperature, the maximum current density obtained from lithium symmetric cell cycling also increases with temperature. At 150° C. (FIG. 7B), the symmetric cell can be cycled steadily at 1.8 mA cm⁻². Temperature also affects the shape of the potential profile. It takes only a few minutes for the voltage to reach a steady plateau, which corresponds to establishment of a steady-state salt concentration gradient across the cell, during plating and stripping processes at 60° C. and higher temperatures. However, more than 0.5 h is needed at 23° C. to establish steady state resulting from the slow ion transport kinetics at low temperature.

Lithium symmetric cells also show long term cycling stability at a given constant current density (FIG. 7C). The coin cell lasts for ≈800 h before failure occurs when cycled at 23° C. using a current density of 0.1 mA cm⁻². When cycled at 100° C. and 0.6 mA cm⁻², the cell lasts for over 700 h. When cycled at 100° C. using a stripping/plating capacity of 3.0 mAh cm⁻², the voltage profile of a cell also shows great stability over 180 h (FIG. 8). These measurements demonstrate excellent compatibility of the MIC membrane with lithium metal even at higher temperatures. From these measurements, we can establish that the active hydrogen atom in the amide group (—CONH—) of the polymer does not catastrophically affect the compatibility of the MIC membrane against lithium metal. We believe this is because the MIC membrane is composed mainly of IL, and a small fraction of the IL is squeezed out of the membrane during cell assembly. This free IL spreads on the surface of lithium metal and forms an SEI layer, which we will discuss further below. This SEI layer eliminates the physical contact between PBDT and lithium metal. As a result, the MIC membrane demonstrates sustainable cycling stability against lithium metal.

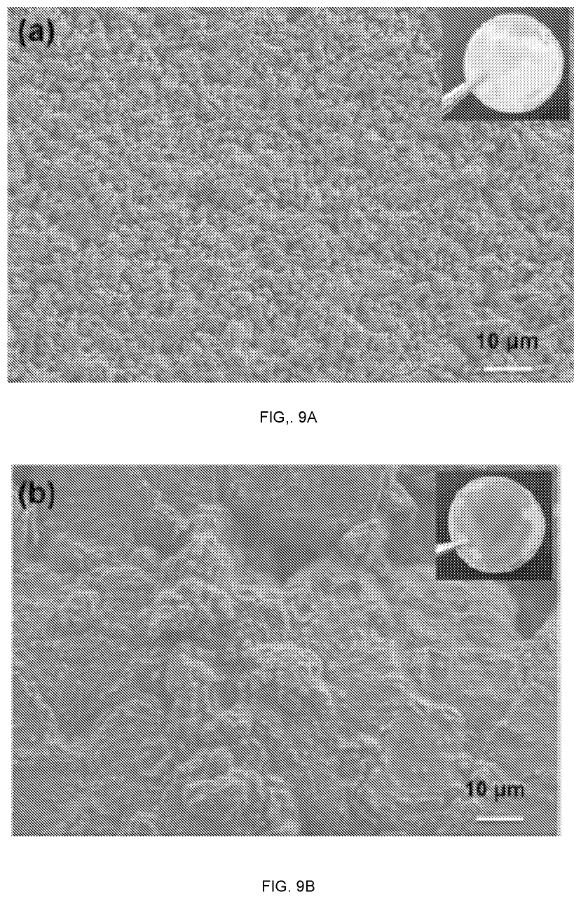

Lithium dendrites are detrimental to the safety of lithium batteries. To investigate the ability of MICs to mitigate dendritic lithium growth, lithium is deposited on Cu foil both at 23 and 150° C. using Cu/MIC/Li cells (FIGS. 9A-9B). Lithium deposited at 23° C. shows a dense granular morphology, and at 150° C. lithium particles tend to form larger aggregates. This may be because lithium becomes softer at high temperatures. No dendritic lithium growth is observed for both cases. Based on the compatibility of the MIC membrane with lithium metal, combined with the wide electrochemical window of Pyr₁₄TFSI, we anticipate that this MIC electrolyte will be suitable for enabling wide-temperature-range lithium metal batteries.

### Performance of Li/MIC/Li FePO₄ Cells

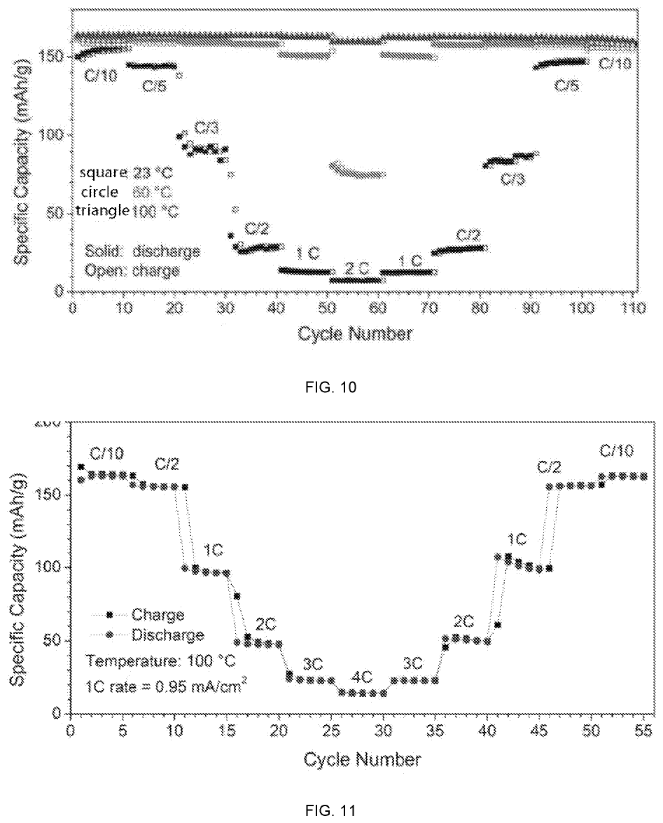

This example employs LiFePO₄ as the cathode material due to its thermal stability and its compatibility with polymer electrolytes [63-66]. FIG. 10 shows the rate capability of Li/MIC/LiFePO₄ batteries at different temperatures. The specific capacity decreases as C-rate increases at 23° C., which is a common phenomenon for lithium metal batteries. The unstable performance at C/3 rate is likely related to the high cell polarization as the current density approaches the limiting current density of MIC membrane, which is <0.2 mA cm⁻² at 23° C. as identified from lithium symmetric cell cycling (FIG. 7A). This low limiting current density also leads to the drop in capacity above C/3 rate at 23° C. The specific capacity at high C-rate can improve with temperature since higher ionic conductivity leads to higher limiting current density. At 100° C., the specific discharge capacity at 2 C rate can reach 160 mAh g⁻¹, and the specific discharge power of LifePO₄ reaches 1100 W kg⁻¹. The specific capacity recovers completely when the charge/discharge rate is slowed, demonstrating excellent electrochemical stability of the MIC membrane at high C rate.

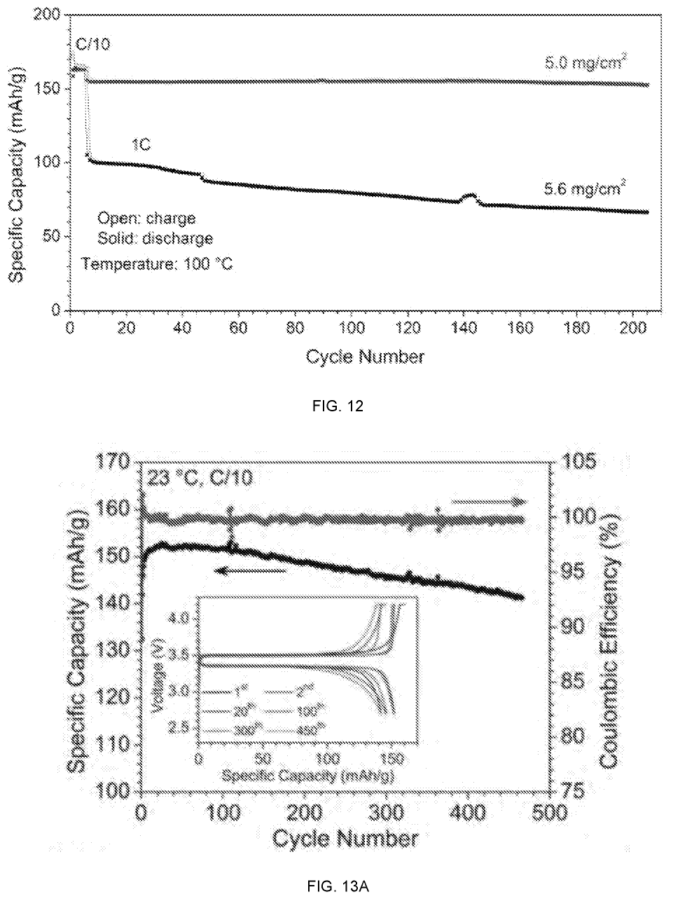

We also evaluate the rate capability at 100° C. using a thick electrode with a LiFePO₄ mass loading of 5.6 mg cm⁻² (FIG. 11). The rate capability of this thick electrode is only slightly inferior to that of a thin electrode. This difference is likely caused by insufficiently connected ionic pathways in the thick electrode, which will likely improve with material processing and cell assembly optimization. Nonetheless, the performance of this thick electrode cell is stable over cycling even at a current density of 0.95 mA cm⁻² (FIG. 12), demonstrating again the excellent electrochemical stability of the MIC membrane at high C rate.

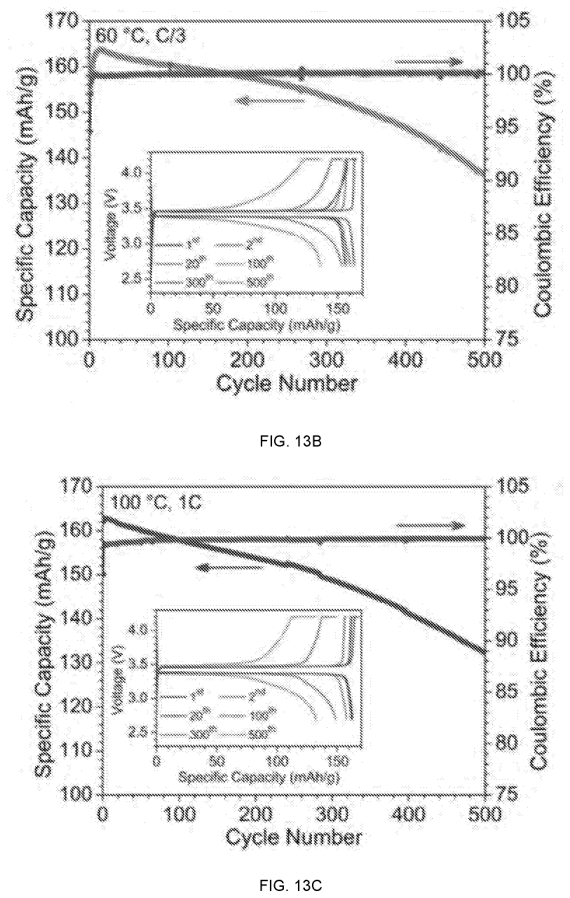

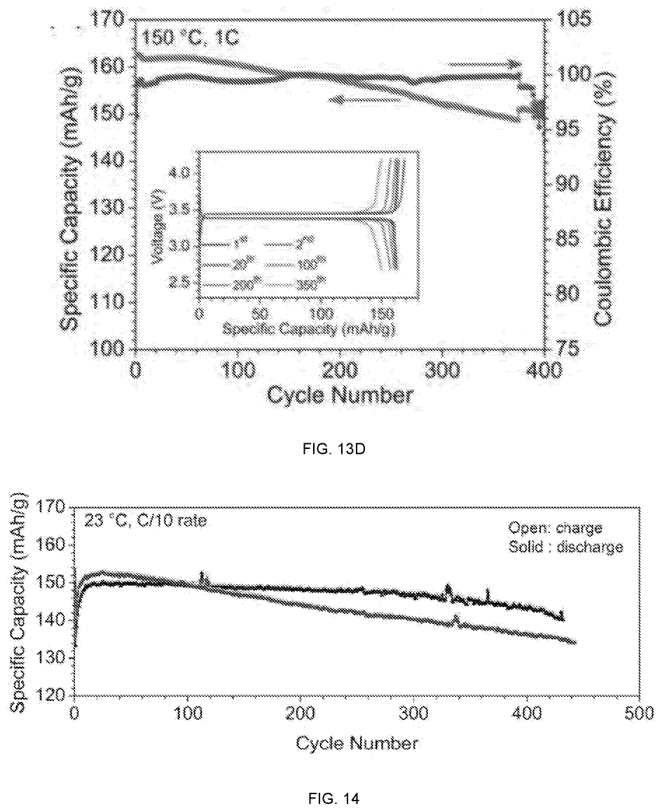

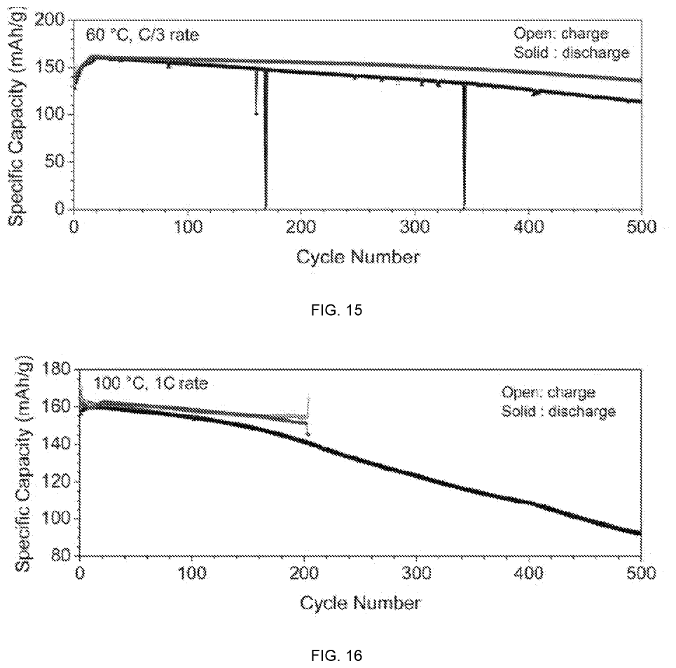

The long-term cycling stability of Li/MIC/LiFePO₄ coin cells is shown in FIGS. 13A-13D. When cycled at 23° C. using C/10 rate (FIG. 13A), the specific capacity demonstrates an increase during the initial few cycles probably resulting from improved contact between the cathode and the electrolyte. The Coulombic efficiency, the ratio between discharge capacity and charge capacity, is above 99.5% during cycling, demonstrating that the MIC is electrochemically stable. The specific discharge capacity reaches a maximum of 150 mAh g⁻¹ and with a high retention of 94% after 400 cycles, again signifying the MIC's stability. When the LI/MIC/LiFePO₄ battery is cycled at 60° C. using C/3 rate (FIG. 13B), the maximum specific capacity obtained is 164 mAh g⁻¹ and the discharge capacity retention after 500 cycles is 83%. This cycling performance at 23 and 60° C. is reproducible, with additional coin cell cycling data shown in FIGS. 14-15.

The capacity decay after 250 cycles at 60° C. accelerates, which is also reflected by the change in voltage profile where the charge/discharge voltage deviates from the voltage plateau. This is attributed to the accumulation of side reaction products at elevated temperature. Research has shown that TFSI⁻ decomposes on the surface of lithium metal, contributing to the SEI layer [41, 67, 68] TFSI− causes the reduction peaks at 0.7 and 1.5 V in cyclic voltammetry

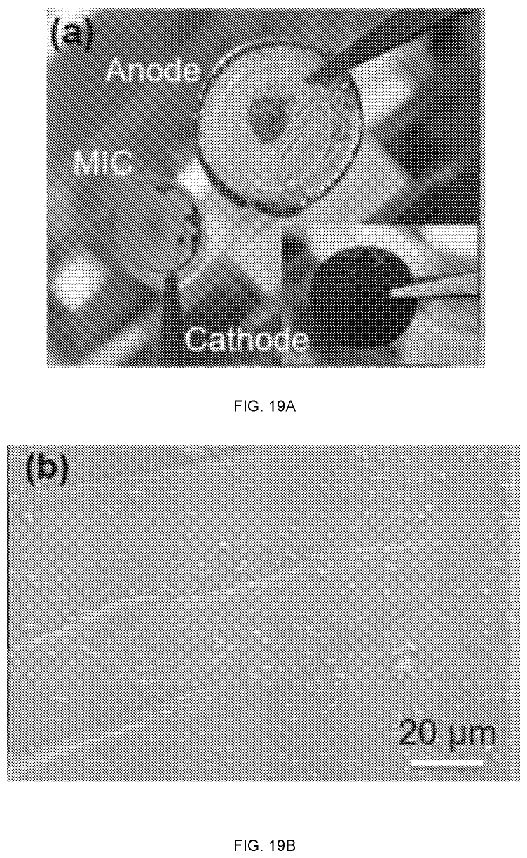

(CV) of the MIC membrane (FIG. 18) [68]. These peaks are also seen in the CV characterization of a liquid mixture of LiTFSI and Pyr₁₄TFSI in a mass ratio of 1:8 (FIG. 18). Besides the decomposition of TFSI-against lithium metal, an oxidation peak at 3.9 V appears for the MIC membrane, which may be caused by the polymer or an impurity as it is not observed in the liquid mixture of LiTFSI and Pyr₁₄TFSI. This oxidation reaction at 3.9 V could also contribute to the decay of cell performance over cycling.

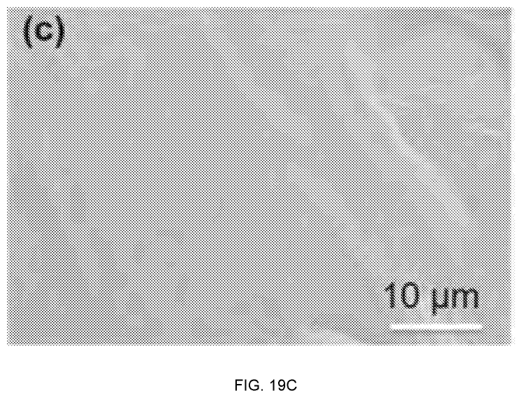

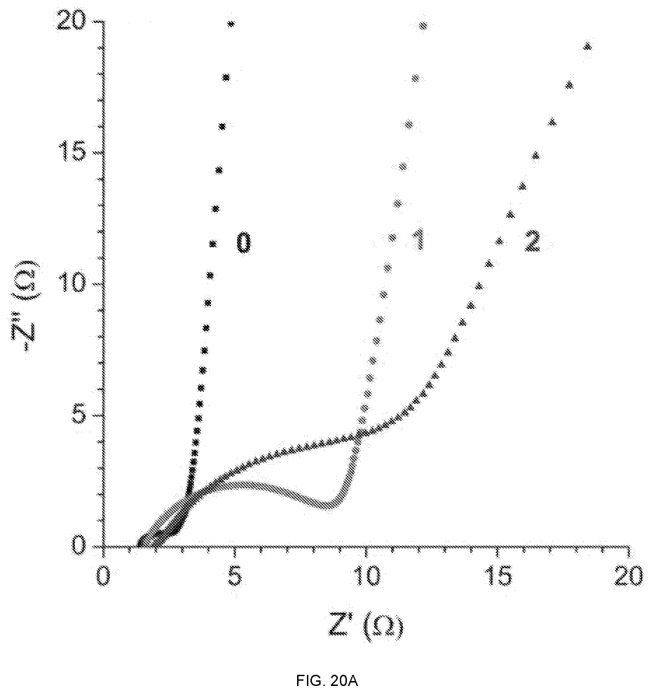

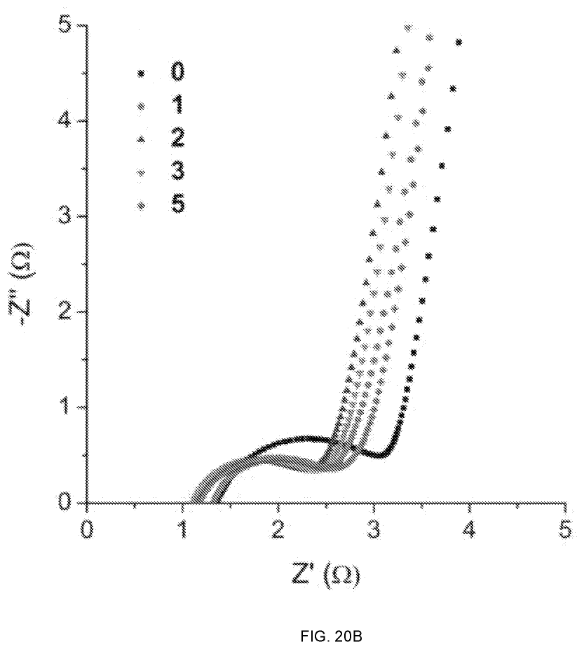

The MIC membrane maintains its mechanical integrity after 500 cycles at 60° C. (FIGS. 19A-19C). Only slight color change is observed at the central part of the membrane most likely coming from side reactions. When examined under SEM (FIGS. 19B-19C), both sides of the membrane are smooth except for some particles coming from the cathode.

When a LI/MIC/LiFePO₄ cell is cycled at 100° C. using 1 C rate (FIG. 13C), the maximum specific discharge capacity reaches 163 mAh g⁻¹. The capacity decay and voltage profile change is similar to that at 60° C. Although not every coin cell can successfully reach 500 cycles at 100° C. for the three coin cells shown in FIG. 13C and FIG. 16, the average discharge capacity retention after 150 cycles is 95%.

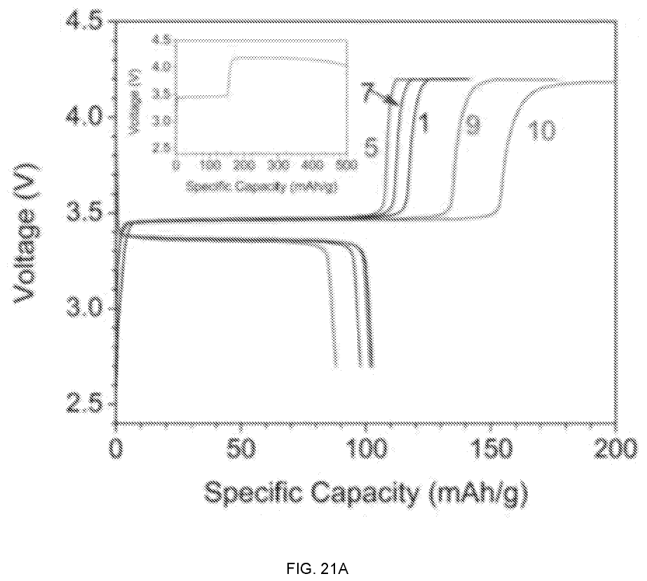

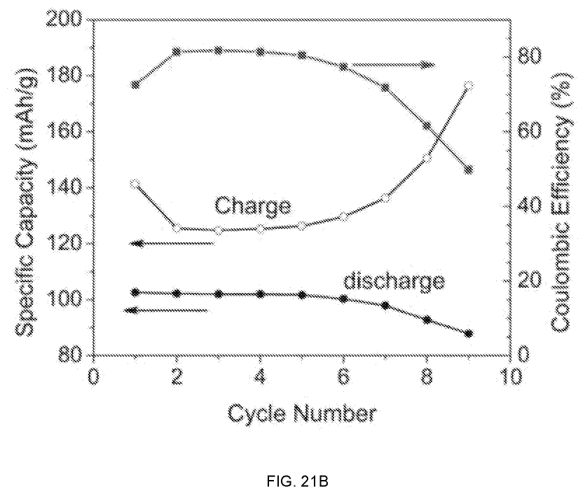

For the thin electrode Li/MIC/LIFePO₄ batteries cycled at 23, 60, and 100° C., a 0.5 h constant voltage charge process at 4.2 V is applied. When the temperature is raised to 150° C., it turns out that this constant voltage charging process at 4.2 V causes failure of coin cells within 2-3 cycles. A drastic increase in interfacial resistance is observed by impedance analysis (FIGS. 20A-20B). When this voltage hold process is removed from the cycling protocol, this increase in interfacial resistance is eliminated and Li/MIC/LiFePO₄ can withstand many more cycles. This suggests that side reactions happen mainly in the high voltage region, and the oxidation peak identified at 3.9 V versus Li from CV measurement appears to be the major reason for capacity decay when applying this constant voltage charge process at 4.2 V.

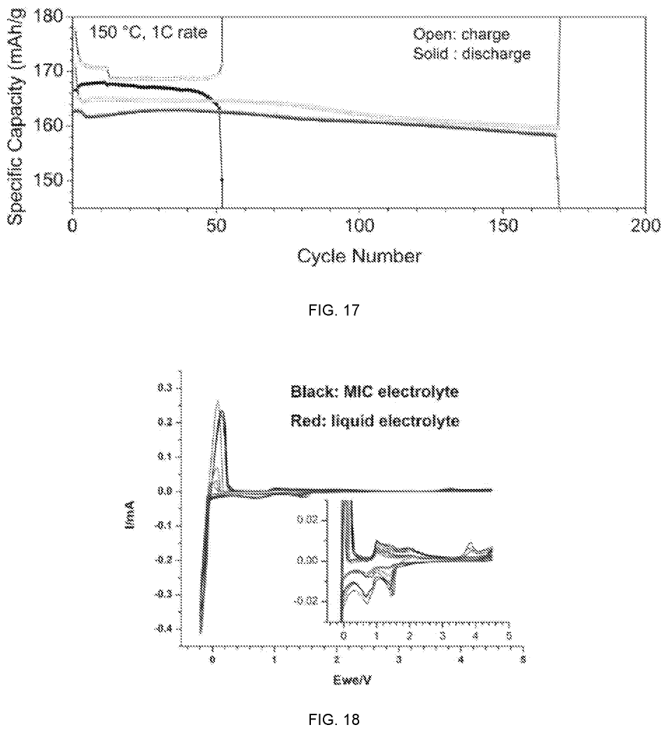

FIG. 13D shows a cell cycled at 150° C. using 1 C rate that lasted for 374 cycles with a discharge capacity retention of 91%. When compared to the long-term cycling data at 100° C. (FIG. 13C), the capacity decay at 150° C. is even slower. This also suggests that the constant voltage charging process used for cycling at ˜100° C. dominates capacity decay. Cycling data for two additional coin cells at 150° C. are shown in FIG. 17. Although these coin cells fail after different numbers of cycles, no drastic capacity decay or voltage profile change is observed before failure, and the average Coulombic efficiency for these three cells during the initial 50 cycles are all >98.5%. The average discharge capacity retention of these three coin cells after 50 cycles is as high as 99%. This suggests that the MIC electrolyte at 150° C. is still highly stable. Success in obtaining consistent cycling performance at 100 and 150° C. is likely disrupted by the reduced sealing property of the coin cell gasket at these temperatures. The poor high temperature mechanical properties of the binder, PVDF, used in the cathode may also cause capacity decay [69, 70]. To the best of our knowledge, this is the highest temperature polymer-based gel used as solid electrolyte for lithium metal battery cycling. The stable high temperature performance of this MIC membrane makes it an ideal electrolyte for investigating the performance of more energy-dense cathode materials at high temperature and high rate.

### Conclusions

A rigid MIC membrane that contains only 10 wt % polymer is prepared, characterized and integrated into lithium metal battery cells. The MIC membrane remains mechanically stable up to 200° C. with a shear storage modulus of ≈10 MPa. Lithium metal batteries built using this solid electrolyte demonstrate strong cycling performance over a wide temperature range from 23 to 150° C. At this time, since the melting point of lithium metal is 180° C., cycling at temperatures higher than 150° C. has not been measured. Overall, MIC electrolytes constructed from lithium salt, ionic liquid, and the rigid-rod ionic polymer PBDT hold excellent potential for electrochemical devices that can operate over wide temperature ranges.

### REFERENCES

[1] M. Tarascon, M. Armand, Nature 2001, 414, 359.
[2] J.B. Goodenough, Y. Kim, Chem. Mater. 2010, 22, 587.
[3] G. E. Blomgren,J. Electrochem. Soc. 2016, 164, A5019.
[4] K. Liu, Y. Liu, D. Lin, A. Pei, Y. Cui, Sci. Adv. 2018, 4, eaas9820.
[5] S. Sharifi-Asl, J. Lu, K. Amine, R. Shahbazian-Yassar, Adv. Energy Mater. 2019, 9, 1900551.
[6] K. Xu, Chem. Rev. 2004, 104, 4303.
[7] X. Lin, M. Salari, L. M. R. Arava, P. M. Ajayan, M. W. Grinstaff, Chem. Soc. Rev. 2016, 45, 5848.
[8] D. R. Wright, N. Garcia-Araez, J. R. Owen, Energy Procedia 2018, 151, 174.
[9] D. Munoz-Rojas , J .-8. Leriche, C. Delacourt, P. Poizot, M. R. Palacin, J.M . Tarascon, Electrochem. Commun. 2007, 9, 708.
[10] K. Kalaga, M .-T. F. Rodrigues , H. Gullapalli, G. Babu, L. M. R. Arava, P. M. Ajayan, ACS Appl. Mater. Inte, faces 2015, 7, 2sm.
[11] P. Bai, J. Li, F. R. Brushen, M. Z. Bazant, Energy Environ. Sci. 2016, 9, 3221.
[12] W. Xu, J. Wang, F. Ding, X. Chen, E. Nasybulin, Y. Zhang, J.G. Zhang, Energy Environ. Sci. 2014, 7, 513.
[13] J P. Novak, P. Podhajecky,J. Power Sources 1991, 35, 235.
[14] Y .-H . Li, X .-L. Wu, J .-H. Kim, S. Xin, J. Su, Y. Yan, J .-S. Lee, Y .-G. Guo, J. Power Sources 2013, 244, 234.
[15] X .-L. Wu, Y .-H. Li, N. Wu, S. Xin, J .-H. Kim, Y. Yan, J .-S. Lee, Y .-G. Guo, Solid State lonics 2013, 245-246, I.
[16] Q. Hu, S. Osswald, R. Daniel, Y. Zhu, S. Wesel, L. Ortiz, D. R. Sadoway, J. Power Sources 2011, 196, 5604.
[17] J. Zhang, L. Yue, P. Hu, Z. Liu, 8. Qin, 8. Zhang, Q. Wang, G. Ding, C. Zhang, X. Zhou, J. Yao, G. Cui, L. Chen, Sci. Rep. 2014, 4, 6272.
[18] J. H. Lee, A. S. Lee, J .-C. Lee, S. M. Hong, S.S. Hwang, C. M. Koo, J. Mater. Chem. A 2015, 3, 2226.
[19] X. Zhao, S. Guo, H. Li, J. Liu, X. Liu, H. Song, Macromol. Rapid Commun. 2017, 38, 1700415.
[20] Z. Tang, L. Qi, G. Gao, Solid State Ionics 2008, 179, 1880.
[21] R. Mantravadi, P. R. Chinnam, D. A. Dikin, S. L. Wunder, ACS Appl. Mater. Interfaces 2016, 8, 13426.
[22] N. Sun, X. Gao, A. Wu, F. Lu, L. Zheng, J. Mol. Liq. 2017, 248, 759.
[23] S. Chereddy, J. Aguirre, D. Dikin, S. L. Wunder, P. R. Chinnam, ACS Appl. Energy Mater. 2020, 3, 279.
[24] R. Tamate, K. Hashimoto, T. Horii, M. Hirasawa, X. Li, M. Shibayama, M. Watanabe, Adv. Mater. 2018, 30, 1802792.
[25] J. C. Jansen, K. Friess, G. Clarizia, J. Schauer, P. Izak, Macromolecules 2011, 44, 39.
[26] A. J. D′Angelo, M. J. Panzer, Adv. Energy Mater. 2018, 8, 1801646.
[27] T. P. Lodge, Science 2008, 321, 50.
[28] J. I Nagasawa, H. Matsumoto, M. Yoshida, ACS Macro Lett. 2012, 1, 1108.
[29] S.-Y. Lee, A. Ogawa, M. Kanno, H. Nakamoto, T. Yasuda, M. Watanabe, J. Am. Chem. Soc. 2010, 132, 9764.
[30] Ito, T. Yasuda, X. Ma, M. Watanabe, Polym. J. 2017, 49, 671.
[31] A. Ito, T. Yasuda, T. Yoshioka, A. Yoshida, X. Li, K. Hashimoto, K. Nagai, M. Shibayama, M. Watanabe, Macromolecules 2018, 51, 7112.
[32] E. Hayashi, M. L. Thomas, K. Hashimoto, S. Tsuzuki, A. Ito, M. Watanabe, ACS Appl. Polym. Mater. 2019, 1, 1579.
[33] E. Hayashi, K. Hashimoto, M. L. Thomas, S. Tsuzuki, M. Watanabe, Membranes 2019, 9, 81.
[34] Y. Wang, Y. Chen, J. W. Gao, H. G. Yoon, L. Y. Jin, M. Forsyth, T. J. Dingemans, L.A. Madsen, Adv. Mater. 2016, 28, 2571.
[35] J. E. Bostwick, C. J. Zanelotti, C. Lacob, A.G. Korovich, L.A. Madsen, R. H. Colby, Macromolecules 2020, 53, 1405.
[36] R. J. Fox, D. Yu, M. Hegde, A. S. Kumbhar, L. A. Madsen, T. J. Dingemans, ACS Appl. Mater. Interfaces 2019, 11, 40551.
[37] D. Yu, C. J. Zaneloni, R. J. Fox, T. J. Dingemans, L.A. Madsen, Submined for publication.
[38] Z. Yu, Y. He, Y. Wang, L.A. Madsen, R. Qiao, Langmuir 2017, 33, 322.
[39] J.-K. Kim, L. Niedzicki, J. Scheers, C .-R. Shin, D .-H. Lim, W. Wieczorek, P. Johansson, J .-H. Ahn, A. Matic, P. Jacobsson, J. Power Sources 2013, 224, 93.
[40] G.-T. Kim, S. Passerini, M. Care.I(ska, G. 8. Appetecchi, Membranes 2018, 8, 41.
[41] P. C. Howlen, D. R. MacFarlane, A. F. Hollenkamp, Electrochem. Solid-State Lett. 2004, 7, A 97.
[42] L. Long, S. Wang, M. Xiao, Y. Meng, j. Mater. Chem. A 2016, 4,10038.
[43] J. Y. Song, Y. Y. Wang, C. C. Wan, J. Power Sources 1999, 77, 183.
[44] W. H. Woodford, W. C. Carter, Y .-M. Chiang, Energy Environ . Sci. 2012, 5, 8014.
[45] S. R. Bishop, D. Marrocchelli, C. Chatzichristodoulou, N. H. Perry, M. B. Mogensen, H. L. Tuller, E. D. Wachsman, Annu. Rev. Mater. Res. 2014, 44, 205.
[46] Y. Ren, J. Guo, Z. Liu, Z. Sun, Y. Wu, L. Liu, F. Yan, Sci. Adv. 2019, 5, 0648.
[47] K. Matsumoto, S. Sogabe, T. Endo, J. Polym. Sci., Part A: Polym. Chem. 2010, 48, 4515.
[48] Z. Tang, X. Lyu, A. Xiao, Z. Shen, X. Fan, Chem. Mater. 2018, 30, 7752.
[49] F. B. Dias, L. Plomp, J. 8. J. Veldhuis, J. Power Sources 2000, 88, 169.
[50] I. Nicotera, L. Coppola, C. Oliviero, G. A. Ranieri, Ionics 2005, 11, 87.
[51] D. R. MacFarlane, P. Meakin, J. Sun, N. Amini, M. Forsyth, J. Phys. Chem. B 1999, 103, 4164.
[52] H. Tokuda, K. Ishii, M. A. 8. H. Susan, S. Tsuzuki, K. Hayamizu, M. Watanabe, J. Phys. Chem. B 2006, 110, 2833.
[53] M. Kunze, S. Jeong, E. Paillard, M. Schonhoff, M. Winter, S. Passerini, Adv. Energy Mater. 2011, 1, 274.
[54] C. A. Angell, Electrochim. Acta 2017, 250, 368.
[55] F. Kremer, A. Schonhals, Broadband Dielectric Spectroscopy, Springer-Verlag, Berlin 2003.
[56] Y. Wang, J. W. Gao, T. J. Dingemans, L.A. Madsen, Macromolecules 2014, 47, 2984.
[57] Y. Wang, Y. He, Z. Yu, J. Gao, S. ten Brinck, C. Slebodnick, G. 8. Fahs, C. J. Zanelotti, M. Hegde, R. B. Moore, 8. Ensing, T. J. Dingemans, R. Qiao, L. A. Madsen, Nat. Commun. 2019, 10, 801.
[58] S. Zugmann, M. Fleischmann, M. Amereller. R. M. Gschwind, H. D. Wiemhofer, H. J. Gores, Electrochim. Acta 2011, 56, 3926.
[59] X .-8. Cheng, R. Zhang, C .-Z. Zhao, Q. Zhang, Chem. Rev. 2017, 117, 10403.
[60] M. Rosso, C. Brissot, A. Teyssot, M. Dolle, L. Sannier, J .-M. Tarascon, R. Souchet, S. Lascaud, Electrochim. Acta 2006, 51, 5334.
[61] D. M. Pesko, Z. Feng, S. Sawhney, J. Newman, V. Srinivasan, N. P. Balsara,J. Electrochem. Soc. 2018, 165, A3186.
[62] A. K. Padhi, K. S. Nanjundaswamy, J. B. Goodenough, J. Electrochem. Soc. 1997, 144, 1188.
[63] H. Duan, Y .-X. Yin, X .-X. Zeng, J .-Y. Li, J .-L. Shi, Y. Shi, R. Wen, Y .-G. Guo, L .-J. Wan, Energy Storage Mater. 2018, 70, 85.
[64] X. Pan, T. Liu, D. J. Kautz, L. Mu, C. Tian, T. E. Long, P. Yang, F. Lin, j. Power Sources 2018, 403, 127.
[65] D. G. Mackanic, W. Michaels, M. Lee, D. Feng, J. Lopez, J. Qin, Y. Cui, Z. Bao, Adv. Energy Mater. 2018, 8, 1800703.
[66] Y. Zhu, S. Xiao, Y. Shi, Y. Yang, Y. Hou, Y. Wu, Adv. Energy Mater. 2014, 4, 1300647.
[67] P. C. Howlett, N. Brack, A. F. Hollenkamp, M. Forsyth, D. R. MacFarlane,J. Electrochem. Soc. 2006, 753, A595.
[68] P. C. Howlett, E. I. Izgorodina, M. Forsyth, D. R. MacFarlane, Z. Phys. Chem. 2006, 220, 1483.
[69] L. Bodenes, R. Nature!, H. Martinez, R. Dedryvere, M. Menetrier, L. Croguennec, J .-P. Peres, C. Tessier, F. Fischer. J. Power Sources 2013, 236, 265.
[70] M.-T. F. Rodrigues, K. Kalaga, H. Gullapalli, G. Babu, A. L. M. Reddy, P. M. Ajayan, Adv. Energy Mater. 2016, 6, 1600218.
[71] J. Gao, Y. Wang, 8. Norder. S. J. Garcia, S. J. Picken, L.A. Madsen, T. J. Dingemans,J. Membr. Sci. 2015, 489, 194.
[72] N. Sarkar, L. D. Kershner, J. Appl. Polym. Sci. 1996, 62, 393.
[73] E. 0. Stejskal, J. E. Tanner, J. Chem. Phys. 1965, 42, 288.
[74] J. Evans, C. A. Vincent, P. G. Bruce, Polymer 1987, 28, 2324.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A composite electrolyte comprising:
a) an alkali metal salt of an aromatic polyimide polymer; and
b) an ionic liquid;
wherein the composite is a solid at 25° C. and at a temperature of about 200°° C.

2. The composite electrolyte according to claim 1, wherein the composite has a tensile modulus of about 0.03 GPa to about 3 GPa at a temperature of about 23° C.

3. The composite electrolyte according to claim 1, wherein the composite has a tensile strength of about 1 MPa to about 100 MPa at a temperature of about 23° C.

4. The composite electrolyte according to claim 1, wherein the composite has a strain at break of about 0.5% to about 20% at a temperature of about 23° C.

5. The composite electrolyte according to claim 1, wherein the composite has a shear storage modulus at 200° C. that is at least 60% of a reference shear storage modulus measured for the otherwise same composite electrolyte except measured at a temperature of 25° C.

6. The composite electrolyte according to claim 1, wherein the alkali metal salt of the aromatic polyimide polymer is present in an amount from about 5 weight percent to about 25 weight percent based on a total weight of the composite electrolyte.

7. The composite electrolyte according to claim 1, wherein the ionic liquid is present in an amount from about 50 weight percent to about 95 weight percent based on a total weight of the composite electrolyte.

8. The composite electrolyte according to claim 1, further comprising a small molecule alkali metal salt dopant, wherein the dopant is present in an amount form about 1 weight percent to about 20 weight percent based upon a total weight of the composite electrolyte.

9. The composite electrolyte according to claim 1, wherein the composite electrolyte has an ionic conductivity of about 1×10⁻⁶ S/cm to about 1.5×10⁻² S/cm when measured at 25° C.

10. The composite electrolyte according to claim 1, any one of claims 1-5, wherein the alkali metal is selected from the group consisting of sodium, lithium, and potassium, preferably lithium.

11. The composite electrolyte according to claim 1, wherein the aromatic polyimide polymer is poly(2,2′-disulfonyl-4,4′-benzidine terephthalamide) or a derivative thereof.

12. The composite electrolyte according to claim 1, wherein the small molecule alkali metal salt dopant is

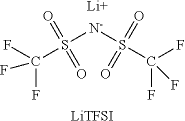

13. The composite electrolyte according to claim 1, wherein the ionic liquid comprises

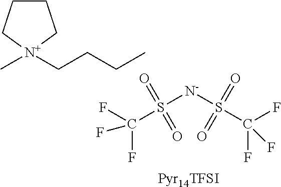

14. The composite electrolyte according to claim 1, wherein the electrolyte is made by a process comprising casting an aqueous solution of the alkali metal salt of the aromatic polyimide polymer; the ionic liquid, and optionally the small molecule alkali metal salt dopant to form the composite electrolyte.

15. The composite electrolyte according to claim 1, wherein the aromatic polyimide polymer is poly(2,2′-disulfonyl-4,4′-benzidine terephthalamide) or a derivative thereof;
wherein the small molecule alkali metal salt dopant is 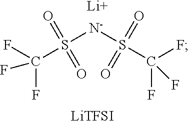
and
wherein the ionic liquid comprises

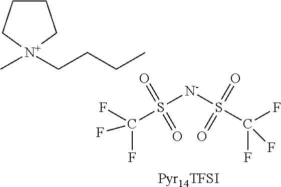

16. A battery comprising an alkali metal anode, a composite electrolyte according to claim 1, and a suitable cathode.

17. The battery according to claim 16, wherein the alkali metal is lithium and the alkali metal anode is a lithium anode.

18. The battery according to claim 17, wherein the suitable cathode is LifePO₄.

19. The battery according to claim 16, wherein the battery has a discharge capacity of about 120 to about 170 mAh/g at a 1 C rate when measured at 100° C. to about 150° C.

20. The battery according to claim 16, any one of claims 16-18, wherein the battery has a discharge capacity retention of at least 90% or at least 95% or at least 99% when measured over 50, 100, or 150 cycles at a temperature of about 100° C. to about 150.
